(19) United States
(12) Patent Application Publication
(10) Pub. No.: US 2005/0171301 A1
(43) Pub. Date: Aug. 4, 2005

(54) Reworkable thermosetting resin compositions

(75) Inventor: Takahisa Doba, Kanazawa-Ku (JP)

Correspondence Address: LOCTITE CORPORATION, 1001 Trout Brook Crossing, Rocky Hill, CT, 06067, US

(73) Assignee: LOCTITE CORPORATION

(21) Appl. No.: 09/901,581

(22) Filed: Jul. 9, 2001

Related U.S. Application Data
(60) Provisional application No. 60/210,470, filed on Jun. 9, 2000.

(51) Int. Cl. C08L 63/00

(52) U.S. Cl. 525/524; 525/525; 525/526

(57) ABSTRACT

The present invention provides a thermosetting resin composition useful as an underfilling sealing resin which enables a semiconductor device, such as a CSP/BGA/LGA assembly which includes a semiconductor chip mounted on a carrier substrate, to be securely connected to a circuit board by short-time heat curing and with good productivity, which demonstrates excellent heat shock properties (or thermal cycle properties), and permits the CSP/BGA/LGA assembly to be easily removed from the circuit board in the event of semiconductor device or connection failure.

### BACKGROUND OF THE INVENTION

1. Field of the Invention

This invention relates to thermosetting resin compositions useful for mounting onto a circuit board semiconductor devices, such as chip size or chip scale packages (“CSPs”), ball grid arrays (“BGAs”), land grid arrays (“LGAs”) and the like, each of which having a semiconductor chip, such as large scale integration (“LSI”), on a carrier substrate. Reaction products of the compositions of this invention are controllably reworkable when subjected to appropriate conditions.

2. Brief Description of Related Technology

In recent years, the popularity of small-sized electronic appliances, such as camera-integrated video tape recorders (“VTRs”) and portable telephone sets, has made size reduction of LSI devices desirable. As a result of these reduction desires, CSPs, BGAs and LGAs are being used to reduce the size of packages substantially to that of bare chips. Such CSPs, BGAs and LGAs improve the characteristics of the electronic device while retaining many of their operating features, thus serving to protect semiconductor bare chips, such as LSIs, and facilitate testing thereof.

Ordinarily, the CSP/BGA/LGA assembly is connected to electrical conductors on a circuit board by use of a solder connection or the like. However, when the resulting CSP/BGA/LGA/circuit board structure is exposed to thermal cycling, vibration, distortion or is dropped, the reliability of the solder connection between the circuit board and the CSP/BGA/LGA often becomes suspect. Recently, after a CSP/BGA/LGA assembly is mounted on a circuit board, the space between the CSP/BGA/LGA assembly and the circuit board is often now filled with a sealing resin (often referred to as underfill sealing) in order to relieve stresses caused by thermal cycling, thereby improving heat shock properties and enhancing the reliability of the structure.

However, since thermosetting resins are typically used as the underfill sealing material, in the event of a failure after the CSP/BGA/LGA assembly is mounted on the circuit board, it is very difficult to replace the CSP/BGA/LGA assembly without destroying or scrapping the structure in its entirety.

To that end, techniques for mounting a bare chip on a circuit board are accepted as substantially similar to the mounting of a CSP/BGA/LGA assembly onto a circuit board. One such technique, disclosed in Japanese Laid-Open Patent Publication No. 102343/93, involves a mounting process where a bare chip is fixed and connected to a circuit board by use of a photocurable adhesive, where, in the event of failure, this bare chip is removed therefrom. However, this technique is limited to those instances where the circuit board includes a transparent substrate (e.g., glass) which permits exposure to light from the back side, and the resulting structure exhibits poor heat shock resistance.

Japanese Laid-Open Patent Publication No. 69280/94 discloses a process where a bare chip is fixed and connected to a substrate by use of a resin capable of hardening at a predetermined temperature. In the event of failure, this bare chip is removed from the substrate by softening the resin at a temperature higher than the predetermined temperature. However, no specific resin is disclosed, and there is no disclosure about treating the resin which remains on the substrate. Thus, the disclosed process is at best incomplete.

As pointed out in Japanese Laid-Open Patent Publication No. 77264/94, it is conventional to use a solvent to remove residual resin from a circuit board. However, swelling the resin with a solvent is a time-consuming process and the corrosive organic acid ordinarily used as the solvent may reduce the reliability of the circuit board. Instead, that disclosure speaks to a method for removing residual resin by irradiation with electromagnetic radiation.

Japanese Laid-Open Patent Publication No. 251516/93 also discloses a mounting process using bisphenol A type epoxy resin (CV5183 or CV5183S; manufactured by Matsushita Electric Industrial Co., Ltd.). However, the removal process so disclosed does not consistently permit easy removal of the chip, the curing step is lengthy at elevated temperatures, and the process generally results in poor productivity. Of course, mechanical methods of removing/replacing semiconductor chips from/on a substrate are known, such as by cutting the chip to be removed/replaced. See U.S. Pat. No. 5,355,580 (Tsukada).

Thermoplastic underfill resins are known for use in semiconductor chip attachment. See U.S. Pat. No. 5,783,867 (Belke, Jr.). However, such thermoplastic resins tend to leak under relatively modest temperature conditions. In contrast, thermosetting resins cure into a matrix which ordinarily have greater thermal stability under end use operating temperatures.

U.S. Pat. No. 5,512,613 (Afzali-Ardakani), U.S. Pat. No. 5,560,934 (Afzali-Ardakani), and U.S. Pat. No. 5,932,682 (Buchwalter) each refer to a reworkable thermoset composition based on a diepoxide component in which the organic linking moiety connecting the two epoxy groups of the diepoxide includes an acid cleavable acyclic acetal group. With such acid cleavable acyclic acetal groups forming the bases of the reworkable composition, a cured thermoset need only be introduced to an acidic environment in order to achieve softening and a loss of much of its adhesiveness.

U.S. Pat. No. 5,872,158 (Kuczynski) refers to thermosetting compositions capable of curing upon exposure to actinic radiation, which are based on acetal diacrylates, and reaction products of which are reported to be soluble in dilute acid.

U.S. Pat. No. 5,760,337 (Iyer) refers to thermally reworkable crosslinked resins to fill the gap created between a semiconductor device and a substrate to which it is attached. These resins are produced by reacting a dienophile (with a functionality greater than 1) with a 2.5-dialkyl substituted furan-containing polymer.

International Patent Publication No. PCT/US98/00858 refers to a thermosetting resin composition capable of sealing underfilling between a semiconductor device including a semiconductor chip mounted on a carrier substrate and a circuit board to which said semiconductor device is electrically connected. The composition includes about 100 parts by weight of an epoxy resin, about 3 to about 60 parts by weight of a curing agent, and about 1 to about 90 parts by weight of a plasticizer. There, the area around the cured thermoset is heated at a temperature of about 190 to about 260° C. for a period of time ranging from about 10 seconds to about 1 minute in order to achieve softening and a loss of much of its adhesiveness.

U.S. Pat. No. 5,948,922 (Ober) and U.S. Pat. No. 5,973,033 (Ober), each refer to a certain class of compounds having tertiary oxycarbonyl linkages, and compositions based on such compounds, which when cured provide thermally decomposable compositions capable of being reworked.

Notwithstanding the state-of-the-art, it would be desirable for an underfilling sealing material to provide good productivity and thermal shock resistance, while allowing the substrates with which it is to be used to be readily processed and easily separated from a semiconductor device without too extreme conditions that may compromise the integrity of the semiconductor devices remaining on the substrate or the substrate itself.

### SUMMARY OF THE INVENTION

The present invention provides a thermosetting resin composition useful as an underfilling sealing resin. The composition enables a semiconductor device, such as a CSP/BGA/LGA assembly which includes a semiconductor chip mounted on a carrier substrate, to be securely connected to a circuit board by short-time heat curing and with good productivity, which demonstrates excellent heat shock properties (or thermal cycle properties), and permits the CSP/BGA/LGA assembly to be easily removed from the circuit board in the event of semiconductor device or connection failure.

The thermosetting resin composition which is useful as an underfill sealant between such a semiconductor device and a circuit board to which the semiconductor device is electrically connected, includes an epoxy resin component, a curing agent, a coreactant, at least a portion of which is represented by the following structure: 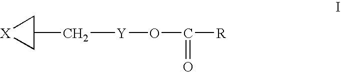
where X represents the heteroatoms, oxygen or sulfur; Y may or may not be present, and when present represents alkyl, alkenyl, aryl and the like; and R represents alkyl, alkenyl, aryl and the like, and a stabilizer which includes cyanate esters.

Reaction products of these compositions are capable of being controllably reworked through the softening and loss of their adhesiveness, such as by exposure to temperature conditions in excess of those used to cure the composition.

Although the thermosetting resin composition of the present invention is curable at a relatively low temperature in a short period of time, cured reaction products thereof have excellent heat shock properties and, moreover, can be easily split by the application of force under appropriate conditions, such as elevated temperature conditions. That is, semiconductor devices attached to circuit boards and the like by cured reaction products of the thermosetting resin compositions of this invention can be easily removed by heating the reaction product, allowing it to swell with a solvent, or allowing it to swell with a solvent under elevated temperature conditions.

By using the thermosetting resin compositions of this invention, semiconductor devices, such as CSP/BGA/LGA assemblies, can be securely connected to a circuit board by short-time heat curing and with good productivity, with the resulting mounting structure demonstrating excellent heat shock properties (or thermal cycle properties). Moreover, in the event of failure, the semiconductor device can be easily removed. This makes it possible to reuse the semiconductor device or circuit board and thereby achieve an improvement in the yield of the production process and a reduction in production cost.

The benefits and advantages of the present invention will become more readily apparent after a reading of the section entitled “Detailed Description of the Invention”, together with reference to the figures which follow.

### BRIEF DESCRIPTION OF THE FIGURES

FIG. 1 depicts a cross-sectional view showing an example of the mounting structure in which the thermosetting resin composition of the present invention is used.

FIG. 2 depicts a flow diagram of a procedure useful to rework a cured thermosetting resin composition in accordance with the present invention, so as to remove a semiconductor device from a circuit board to which it had been attached.

FIG. 3 depicts a FT-IR spectra, performed using attenuated total reflectance, of “ANCAMINE” 2337S.

FIG. 4 depicts a ¹³C NMR spectra of “ANCAMINE” 2337S.

FIG. 5 depicts a thermal gravimetric analytical curve of Sample No. 6.

### DETAILED DESCRIPTION OF THE INVENTION

The thermosetting resin composition which is useful as an underfill sealant between a semiconductor device and a circuit board to which the semiconductor device is electrically connected, includes an epoxy resin component, a curing agent, a coreactant component, at least a portion of which is represented by the following structure: 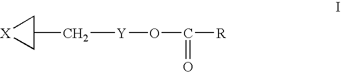
where X represents the heteroatoms, oxygen or sulfur; Y may or may not be present, and when present represents an alkyl (linear, branched, cyclo or bicyclo), alkenyl (linear, branched, cyclo or bicyclo) and the like linkage, such as from one to about twenty carbon atoms, and an aryl [one or more aromatic ring(s) or ring system(s)] linkage, such as from about six to about twenty carbon atoms, and a stabilizer which includes cyanate esters.

Reaction products of the compositions are controllably degradable—for instance, they are capable of softening and losing their adhesiveness under exposure to temperature conditions in excess of those used to cure the composition, with or without the presence of acid. The reaction products are materials having a relatively low Tg, and thus soften readily when exposed to such temperature conditions.

The epoxy resin component should be present in the composition in an amount which the range of about 20% by weight to about 80% by weight, desirably about 20% by weight to about 70% by weight, such as about 47% to about 52% by weight, based on the total weight of the composition.

Ordinarily, a multifunctional epoxy resin should be included as an epoxy resin component.

Examples of such a multifunctional epoxy resin include bisphenol-A-type epoxy resin, bisphenol-F-type epoxy resin (such as RE-404-S from Nippon Kayaku, Japan), phenol novolac-type epoxy resin, and cresol novolac-type epoxy from resin (such as “ARALDITE” ECN 1871 from Ciba Specialty Chemicals, Hawthorne, N.Y.).

Other suitable epoxy resins include polyepoxy compounds based on aromatic amines and epichlorohydrin, such as N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate.

Among the epoxy resins suitable for use herein also include polyglycidyl derivatives of phenolic compounds, such as those available commercially under the tradename “EPON”, such as “EPON” 828, “EPON” 1001, “EPON” 1009, and “EPON” 1031 from Shell Chemical Co.; “DER” 331, “DER” 332, “DER” 334, and “DER” 542 from Dow Chemical Co.; and BREN-S from Nippon Kayaku. Other suitable epoxy resins include polyepoxides prepared from polyols and the like and polyglycidyl derivatives of phenol-formaldehyde novolacs, the latter of which are available commercially under the tradename “DEN”, such as “DEN” 431, “DEN” 438, and “DEN” 439 from Dow Chemical. Cresol analogs are also available commercially under the tradename “ARALDITE”, such as “ARALDITE” ECN 1235, “ARALDITE” ECN 1273, and “ARALDITE” ECN 1299 from Ciba Specialty Chemicals. SU-8 is a bisphenol-A-type epoxy novolac available from Interez, Inc. Polyglycidyl adducts of amines, aminoalcohols and polycarboxylic acids are also useful, commercially available resins of which include “GLYAMINE” 135, “GLYAMINE” 125, and “GLYAMINE” 115 from F.I.C. Corporation; “ARALDITE” MY-720, “ARALDITE” 0500, and “ARALDITE” 0510 from Ciba Specialty Chemicals and PGA-X and PGA-C from the Sherwin-Williams Co.

And of course combinations of the different epoxy resins are also desirable for use herein.

As the curing agent, a variety of materials may be chosen including anhydride compounds, nitrogen-containing compounds, such as aza compounds, amine compounds, amide compounds, imidazole compounds, modified amine compounds, and modified imidazole compounds, and conventional cationic cure initiators and latent cationic cure initiators, such as of the photoinitiating type.

Appropriate anhydride compounds for use herein include mono- and poly-anhydrides, such as hexahydrophthalic anhydride (“HHPA”) and methyl hexahydrophthalic anhydride (“MHHPA”) (commercially available from Lindau Chemicals, Inc., Columbia, S.C., used individually or as a combination, which combination is available under the trade designation “LINDRIDE” 62C) and 5-(2,5-dioxotetrahydrol)-3-methyl-3-cyclohexene-1,2-dicarboxylic anhydride (commercially available from ChrisKev Co., Leewood, Kans. under the trade designation B-4400). In addition, “MTA-15” (mixture of glycol tris-anhydrotrimelitate and MHHPA, commercially available from New Japan Chemical Co., Ltd.) and “MH-700” (MHHPA, commercially available from New Japan Chemical Co., Ltd.) are particularly desirable choices.

Of course, combinations of these anhydride compounds are also desirable for use in the compositions of the present invention.

The nitrogen-containing compounds include aza compounds (such as di-aza compounds or tri-aza compounds), examples of which include: 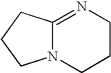
1,5-diazabicyclo[4.3.0]non-5-ene 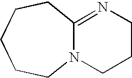
1,8-diazabicyclo[5.4.0]under-7-ene (“DBU”); 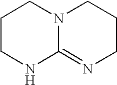
1,5,7-triazabicyclo[4.4.0]dec-5-ene; and
the bicyclo mono- and di-aza compounds: 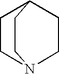
   quinuclidine; and 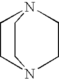
   1,4-diazabicyclo[2.2.2.]octane.

Of course, combinations of these aza compounds may be used in the compositions of the present invention.

Examples of the amine compounds include the following alkyl poly amines: diethylenetriamine, triethylenetetraamine, diethylaminopropylamine, isophoronediamine and menthenediamine; and the aromatic polyamines: m-xylenediamine, diaminodiphenylamine, and quinoxaline.

Of course, combinations of these amine compounds are also desirable for use in the compositions of the present invention.

Examples of the amide compounds include cyano-functionalized amides, such as dicyandiamide.

Examples of the imidazole compounds include imidazole, isoimidazole, and substituted imidazoles—such as alkyl-substituted imidazoles (e.g., 2-methyl imidazole, 2-ethyl-4-methylimidazole, 2,4-dimethylimidazole, butylimidazole, 2-heptadecenyl-4-methylimidazole, 2-undecenylimidazole, 1-vinyl-2-methylimidazole, 2-n-heptadecylimidazole, 2-undecylimidazole, 2-heptadecylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole and addition products of an imidazole and trimellitic acid, 2-n-heptadecyl-4-methylimidazole and the like, generally where each alkyl substituent contains up to about 17 carbon atoms and desirably up to about 6 carbon atoms), and aryl-substituted imidazoles [e.g., phenylimidazole, benzylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5 -diphenylimidazole, 2-(p-dimethylaminophenyl)-4,5-diphenylimidazole, 2-(2-hydroxyphenyl)-4,5-diphenylimidazole, di(4,5-diphenyl-2-imidazole)-benzene-1,4,2-naphthyl-4,5-diphenylimidazole, 1-benzyl-2-methylimidazole, 2-p-methoxystyrylimidazole, and the like, generally where each aryl substituent contains up to about 10 carbon atoms and desirably up to about 8 carbon atoms].

Examples of commercial imidazole compounds are available from Air Products, Allentown, Pa. under the trade designation “CUREZOL” 1B2MZ and from Synthron, Inc., Morganton, N.C. under the trade designation “ACTIRON” NXJ-60.

Of course, combinations of these imidazole compounds are also desirable for use in the compositions of the present invention.

Examples of the modified amine compounds include epoxy amine additives formed by the addition of an amine compound to an epoxy compound, and examples of the modified imidazole compounds include imidazole adducts formed by the addition of an imidazole compound to an epoxy compound.

A commercially available curing agent particularly useful herein is “NOVACURE” HX-3722 (an imidazole/bisphenol A epoxy adduct dispersed in bisphenol A epoxy, commercially available from Asahi-Ciba, Ltd.), and “MY-24” (an imidazole/bisphenol A epoxy adduct, commercially available from Ajinomoto Co., Ltd., Tokyo, Japan).

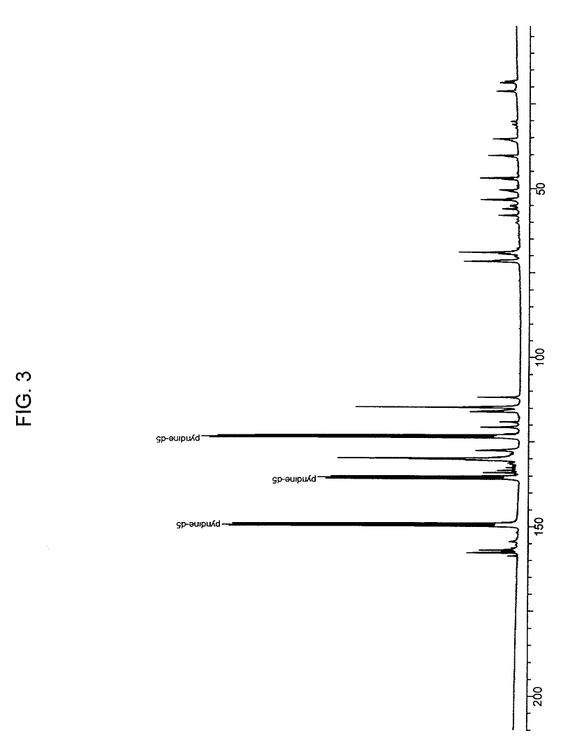

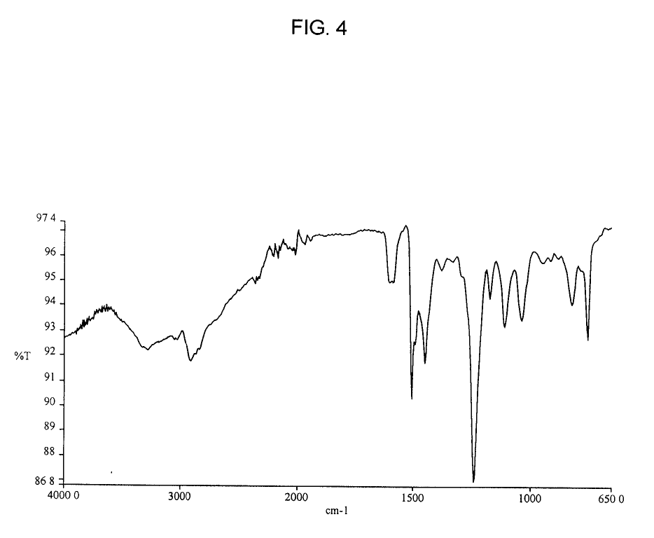

One particularly desirable modified amine compound is available commercially from Air Products and Chemicals, Inc., Allentown, Pa. under the “ANCAMINE” 2337S tradename. “ANCAMINE” 2337S is described by Air Products as a modified aliphatic amine, which is a light yellow powder in appearance with a particle size of 90%≦10μ whose melting point is in the range of 145-172° F. “ANCAMINE” 2337S is reported to have an amine value of 260 (mg KOH/gram), and rapid reactivity above a temperature of 158° F. It is believed that “ANCAMINE” 2337S is a novolac-type resin that has been modified through reaction with aliphatic amines such as polyamines. (See FIGS. 3 and 4.)

Another particularly desirable modified amine, a modified aliphatic polyamine, is available commercially from Asaki Denka Kogyo K.K., Tokyo, Japan, under the tradename Akeda Hardener EH-4070S. This modified aliphatic polyamine is reported to be designed as a latent curing agent for epoxy resins, with an amine value of 237 mg KOH/g and 117 equivalent weight of active hydrogen.

The curing agent should be present in an amount within the range of about 15% by weight to about 50% by weight, desirably about 25% by weight to about 40% by weight, such as about 34 to about 37% by weight, based on the total composition, with the amount depending on the type and identity of the curing agent chosen.

A particularly compound within structure I as the coreactant component includes glycidyl neodecanoate [(CAS Reg. No. 26761-45-5), available commercially from Tohto Kasei Co., Ltd., Tokyo, Japan)], or (CAS Reg. No. 30499-70-8), available commercially from Shell Chemicals Ltd. under the tradename CARDUR E10.

The component represented by structure I should be present in the range of about 1% by weight to about 30% by weight, such as about 5% by weight to about 15% by weight, desirably about 10% weight to about 15% weight, based on the total composition.

The cyanate esters useful as a coreactant include aryl compounds having at least one cyanate ester group on each molecule and may be generally represented by the formula Ar(OCN)ₘ where m is an integer from 2 to 5 and Ar is an aromatic radical. The aromatic radical Ar should contain at least 6 carbon atoms, and may be derived, for example, from aromatic hydrocarbons, such as benzene, biphenyl, naphthalene, anthracene, pyrene or the like. The aromatic radical Ar may also be derived from a polynuclear aromatic hydrocarbon in which at least two aromatic rings are attached to each other through a bridging group. Also included are aromatic radicals derived from novolac-type phenolic resins—i.e., cyanate esters of these phenolic resins. Ar may also contain further ring-attached, non-reactive substituents.

Other examples of such cyanate esters include, for instance, 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane; 2,2-bis(3,5-dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis(4-cyanatophenyl)propane; tris(4-cyanatophenyl)-phosphite; tris(4-cyanatophenyl)phosphate; bis(3-chloro-4-cyanatophenyl)methane; cyanated novolac; and cyanated bisphenol-terminated polycarbonate or other thermoplastic oligomer.

Still other cyanate esters include cyanates disclosed in U.S. Pat. Nos. 4,477,629 and 4,528,366, the disclosure of each of which is hereby expressly incorporated herein by reference; the cyanate esters disclosed in U.K. Patent No. 1,305,702, and the cyanate esters disclosed in International Patent Publication WO 85/02184, the disclosure of each of which is hereby expressly incorporated herein by reference. Of course, combinations of these cyanate esters within the invention are also desirably employed herein.

Particularly desirable cyanate esters are available commercially under the tradename “AROCY”, such as “AROCY” B-10 (CAS No. 1156-5-1-0), M-30 [4,4′-methylene bis (2,6-dimethylphenyl) dicyanate, CAS No. 101657-78-7] and L-10 (ethylidene bis-4,1-phenylene dicyanate, CAS No. 47023-92-2). These three cyanate esters are within the structure represented by: 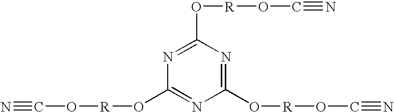
where R is an aromatic structure, such as

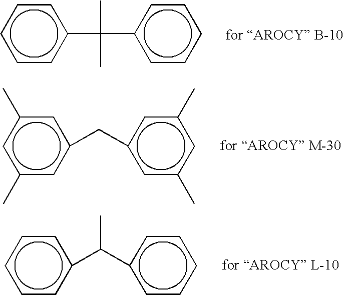

The cyanate ester should be used in the inventive composition in an amount within the range of from about 0.5% by weight to about 5% by weight, such as about 1% by weight to about 4% by weight, desirably 1.5% by weight to about 3% by weight, based on the total composition.

The compositions may also include an inorganic filler component, such as reinforcing silicas, like fused silicas, and may be untreated or treated so as to alter the chemical nature of their surface. Virtually any reinforcing fused silica may be used.

Particularly desirable silicas have a low ion concentration and are relatively small in particle size (e.g., in the range of about 2-10 microns, such as on the order of about 2 microns), such as the one commercially available from Admatechs, Japan under the trade designation SO-E5.

Other desirable materials for use as the inorganic filler component include those constructed of or containing aluminum oxide, silicon nitride, aluminum nitride, silica-coated aluminum nitride, boron nitride and combinations thereof.

When used, the inorganic filler component may be present in an amount within the range of about 5% by weight to about 75% by weight, desirably about 20% by weight to 60% by weight, such as about 40% by weight of the total composition.

The thermosetting resin composition of the present invention may be formulated as a one-part composition, in which all the ingredients are mixed together, or as a two-part composition, in which the epoxy resin and the curing agent are stored separately and mixed thereafter prior to or during use. Accordingly, the curing agent used in the present invention can generally be any of the curing agents which are used in one-part and two-part epoxy resin formulations, particularly those noted above.

The thermosetting resin compositions according to the present invention may further contain other additives, such as defoaming agents, leveling agents, dyes and pigments.

When used as an underfill sealant, the thermosetting resin compositions according to the present invention are capable of penetrating into the space between the circuit board and the semiconductor device. These inventive compositions also demonstrate a reduced viscosity, at least under elevated temperature conditions, and thus are capable of penetrating into that space. It is desirable to prepare the thermosetting resin composition by selecting the types and proportions of various ingredients to reach a viscosity at 25° C. of 10,000 mPa·s or less, such as 4,000 mPa·s, so as to improve its ability to penetrate into the space (e.g., of 100 to 400 μm) between the circuit board and the semiconductor device.

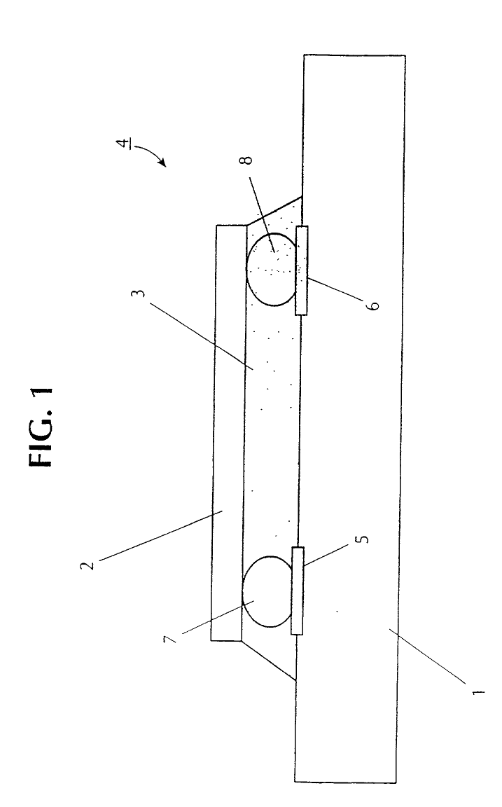

Reference to FIG. 1 shows an example of the mounting structure in which the thermosetting resin composition of the present invention is used as an underfill sealant.

The semiconductor device 4 is one formed by connecting a semiconductor chip (so-called bare chip) 2, such as LSI, to a carrier substrate 1 and sealing the space therebetween suitably with resin 3. This semiconductor device is mounted at a predetermined position of the circuit board 5, and electrodes 8 and 9 are electrically connected by a suitable connection means such as solder. In order to improve reliability, the space between carrier substrate 1 and circuit board 5 is sealed with the cured product 10 of a thermosetting resin composition. The cured product 10 of the thermosetting resin composition need not completely fill the space between carrier substrate 1 and circuit board 5, but may fill it to such an extent as to relieve stresses caused by thermal cycles.

Carrier substrates may be constructed from ceramic substrates made of Al₂O₃, SiN₃ and mullite (Al₂O₃—SiO₂); substrates or tapes made of heat-resistant resins such as polyimides; glass-reinforced epoxy, ABS and phenolic substrates which are also used commonly as circuit boards; and the like.

No particular limitation is placed on the means for electrically connecting the semiconductor chip to the carrier substrate, and there may be employed connection by a high-melting solder or electrically (or anisotropically) conductive adhesive, wire bonding, and the like. In order to facilitate connections, the electrodes may be formed as bumps. Moreover, in order to improve the reliability and durability of connections, the space between the semiconductor chip and the carrier substrate may be sealed with a suitable resin. The semiconductor devices which can be used in the present invention include CSPs, BGAs and LGAs.

No particular limitation is placed on the type of circuit board used in the present invention, and there may be used any of various common circuit boards such as glass-reinforced epoxy, ABS and phenolic boards.

Next, the mounting process is described below. Initially, cream solder is printed at the necessary positions of a circuit board and suitably dried to expel the solvent. Then, a semiconductor device is mounted in conformity with the pattern on the circuit board. This circuit board is passed through a reflowing furnace to melt the solder and thereby solder the semiconductor device. The electrical connection between the semiconductor device and the circuit board is not limited to the use of cream solder, but may be made by use of solder balls. Alternatively, this connection may also be made through an electrically conductive adhesive or an anisotropically conductive adhesive. Moreover, cream solder or the like may be applied or formed on either the circuit board or the semiconductor device. In order to facilitate subsequent repairs, the solder, electrically or anisotropically conductive adhesive used should be chosen bearing in mind its melting point, bond strength and the like.

After the semiconductor device is electrically connected to the circuit board in this manner, the resulting structure should ordinarily be subjected to a continuity test or the like. After passing such test, the semiconductor device may be fixed thereto with a resin composition. In this way, in the event of a failure, it is easier to remove the semiconductor device before fixing it with the resin composition.

Then, using a suitable application means such as dispenser, a thermosetting resin composition is applied to the periphery of the semiconductor device. When this composition is applied to the semiconductor device, it penetrates into the space between the circuit board and the carrier substrate of the semiconductor device by capillary action.

Next, the thermosetting resin composition is cured by the application of heat. During the early stage of this heating, the thermosetting resin composition shows a significant reduction in viscosity and hence an increase in fluidity, so that it more easily penetrates into the space between the circuit board and the semiconductor device. Moreover, by providing the circuit board with suitable venting holes, the thermosetting resin composition is allowed to penetrate fully into the entire space between the circuit board and the semiconductor device.

The amount of thermosetting resin composition applied should be suitably adjusted so as to fill the space between the circuit board and the semiconductor device almost completely.

When the above-described thermosetting resin composition is used, it is usually cured by heating at a temperature of about 80° C. to about 150° C. for a period of time of about 3 to about 60 minutes, such as about 3 to about 15 minutes. Thus, the present invention can employ relatively low-temperature and short-time curing conditions and hence achieve very good productivity. The mounting structure illustrated in FIG. 1 is completed in this manner.

In the mounting process by using the thermosetting resin composition of the present invention, after the semiconductor device is mounted on the circuit board as described above, the resulting structure is tested with respect to characteristics of the semiconductor device, connection between the semiconductor device and the circuit board, other electrical characteristics, and the state of sealing. In the event that a failure is found, a repair can be made in the following manner.

By heating the area around the semiconductor device which has failed is heated at a temperature of about 190° C. to about 260° C. for a period of time ranging from about 10 seconds to about 1 minute. Local heating, such as the application of hot air to the failure site, is particularly desirable for achieving the appropriate temperature conditions.

As soon as the solder is melted and the resin is softened to cause a reduction in bond strength, the semiconductor device is pulled apart.

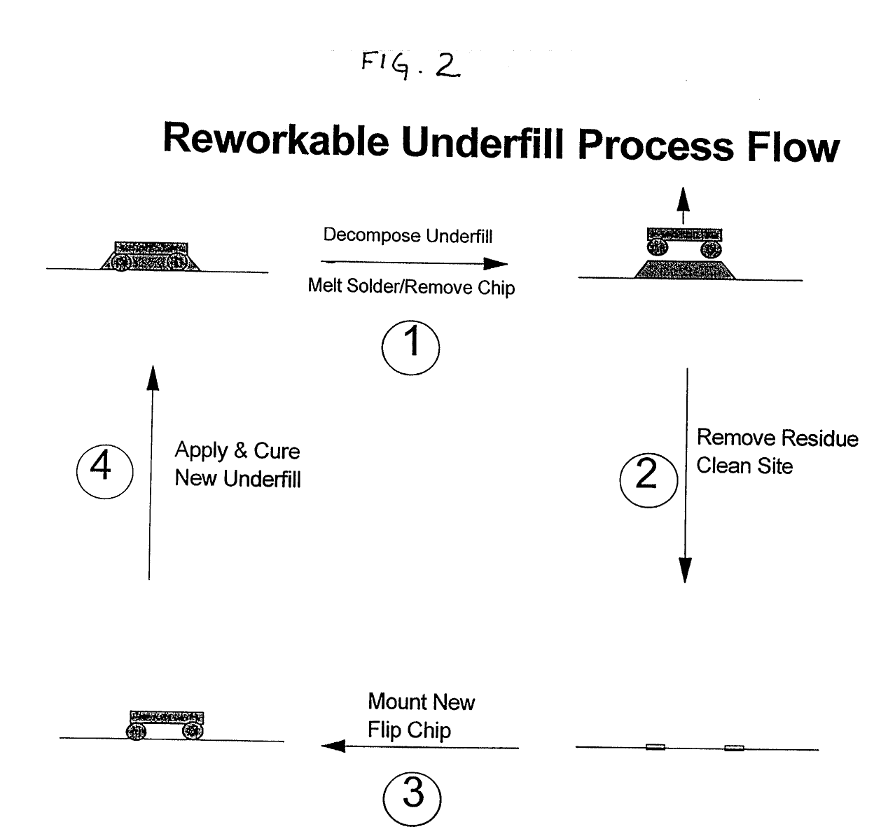

After the semiconductor device 4 is removed as shown in FIG. 2, a residue 12 of the cured reaction product of the thermosetting resin composition and a residue 14 of the solder are left on the circuit board 5. The residue of the cured product of the thermosetting resin composition can be removed, for example, by scraping it off after the residue has been softened by heating it to a predetermined temperature, allowing it to swell with solvent, or allowing it to swell with solvent while heating it to a predetermined temperature.

In this regard, the residue can be easily removed by the entire circuit board at a temperature of about 100° C. (usually in the range of about 80° C. to about 120° C.), with only the localized area heated to a higher temperature.

The solvent used for this purpose is one which causes cured reaction products of the thermosetting resin composition to swell, thereby reducing bond strength to such an extent that the cured material can be scraped off from the circuit board. Useful solvents include organic ones, for example, alkyl chlorides, such as methylene chloride; glycol ethers, such as ethyl cellulose and butyl cellulose; diesters of dibasic acids, such as diethyl succinate; and N-methylpyrrolidone. Of course, appropriate combinations may also be employed.

Where a circuit-protecting resist has already been connected to the circuit board, the chosen solvents should cause no damage to the resist. Desirable solvents with this in mind include glycol ethers and N-methylpyrrolidone.

In this regard, the entire circuit board may be maintained at a temperature of about 100° C. (usually in the range of about 80° C. to a higher temperature, such as about 120° C.), with only the localized are heated.

Finally, on the circuit board which has been cleaned according to the above-described procedure, a new semiconductor device is mounted again in the same manner as described previously. Thus, the repair of the failure site is completed.

Where a failure is found in the circuit board, the semiconductor device can be reused by removing the residue 13 of the cured reaction product of the thermosetting resin composition and the residue 15 of the solder left on the bottom of the semiconductor device in the same manner as described above.

The invention will be further illustrated by the following non-limiting examples.

### EXAMPLES

### Example 1

### Thermosetting Resin Composition

A thermosetting resin compositions in accordance with the present invention may be prepared from the components in ranges as given and as specified below in Tables 1a, 1b and 1c.

TABLE 1a

| | | Sample No./Amt (grams) | | | | | |
|---|---|---|---|---|---|---|---|
| Component | | 1 | | | | | |
| Type | Identity | (range) | 2 | 3 | 4 | 5 | 6 |
| Epoxy | Bisphenol A | 20-80 | — | 51.4 | — | — | 24.5 |
| | Bisphenol F | 20-80 | 51.4 | — | 50.15 | 47.15 | 24.5 |
| Curing | ANCAMINE | 15-50 | 36.3 | 36.3 | 35.37 | 35.37 | 35 |
| Agent | 2337S | | | | | | |
| Coreactant | Glycidyl | 1-30 | 12.3 | 12.3 | 14.48 | 14.48 | 14.5 |
| | neodecanoate | | | | | | |
| Stabilizer | Cyanate Ester | 0.5-5 | — | — | — | 3 | 1.5 |

TABLE 1b

| Component | | Sample No./Amt (grams) | | | | |
|---|---|---|---|---|---|---|
| Type | Identity | 7 | 8 | 9 | 10 | 11 |
| Epoxy | Bisphenol A | — | 27.00 | — | 24.50 | 50.00 |
| | Bisphenol F | 47.15 | 27.00 | — | 24.50 | — |
| Curing | ANCAMINE | — | 20.00 | 49.00 | 24.50 | — |
| Agent | 2337S | | | | | |
| | Akeda Hardener | 35.37 | — | — | 35.00 | 35.00 |
| | EH 4070S | | | | | |
| Coreactant | Glycidyl | 14.48 | 15.00 | 14.00 | 14.50 | 15.50 |
| | neodecanoate | | | | | |
| Stabilizer | Cyanate Ester | 3.00 | 3.001 | 1.50 | 1.50 | — |

TABLE 1c

| Component | | Sample No./Amt (grams) | | | | |
|---|---|---|---|---|---|---|
| Type | Identity | 12 | 13 | 14 | 15 | 16 |
| Epoxy | Bisphenol A | — | — | — | — | — |
| | Bisphenol F | 50.15 | 49.15 | 48.65 | 48.15 | 47.15 |
| Curing | ANCAMINE | 35.37 | 35.37 | 35.37 | 35.37 | 35.37 |
| Agent | 2337S | | | | | |
| Coreactant | Glycidyl | 14.48 | 14.48 | 14.48 | 14.48 | 14.48 |
| | neodecanoate | | | | | |
| Stabilizer | Cyanate Ester | — | 1.00 | 1.50 | 2.00 | 3.00 |

### Physical Properties

In the uncured state, the compositions were observed to have the viscosity value at 25° C. as set forth in Table 2.

In the cured state, reaction products of the compositions were observed to have a glass transition temperature (“Tg”) as measured by dynamic mechanical analysis (“DMA”), α₁ and α₂, and modulus at 25° C. as set forth in Table 2.

TABLE 2

| | Physical Properties | | | | |
|---|---|---|---|---|---|
| Sample | Visc.@25° C. | Tg | α₁ | | Modulus@25° C. |
| No. | (mPas) | (° C.) | (ppm) | α₂ (ppm) | (N/mm²) |
| 2 | 4000 | 41 | 60 | 195 | 5400 |
| 3 | 8000 | — | — | — | — |
| 4 | 4000 | 41 | — | — | — |
| 5 | 3000 | 43 | — | — | — |
| 6 | 3950 | 74 | 55.3 | 207.6 | 9329 |
| 7 | 5000 | 62.2 | 55.4 | 198.5 | 9464 |
| 8 | 4255 | 64.4 | 55.2 | 198.7 | 9900 |
| 9 | 3640 | 58.3 | 57.0 | 202.1 | 8701 |
| 10 | 4300 | 65.1 | 56.6 | 201.1 | 9563 |
| 11 | 8000 | 65.0 | 56.0 | 195.0 | 8300 |

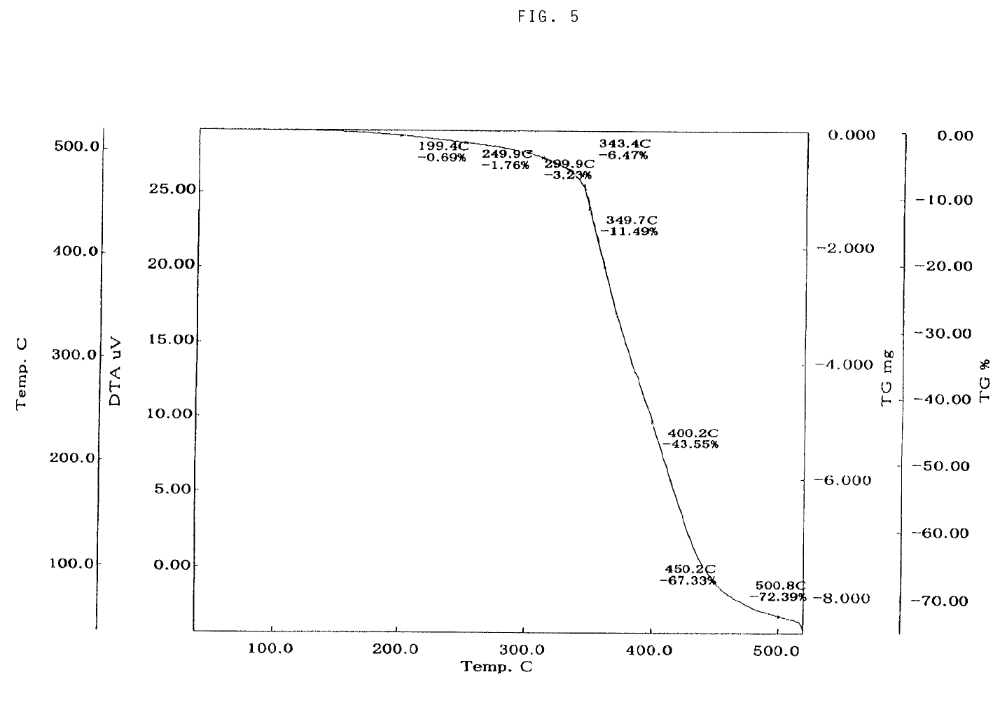

The viscosity of the inventive samples is suitable for use as an underfill sealant. That is, a viscosity less than about 10,000 mPa·s. The Tg values for the samples listed is suitable for use as an underfill sealant. Though not given in Table 2, the cure speed as measured by differential scanning calorimetry (“DSC”) for the samples to reach greater than 90% of cure at a temperature of 50° C. is 3 minutes, at a temperature of 120° C. is 5 minutes, at a temperature 100° C. is 10 minutes and at a temperature of 80° C. is 15 minutes. The thermal gravimetric analytical curve of Sample No. 6 is shown in FIG. 5.

### Mounting Process

Using cream solder (PS10R-350A-F92C; manufactured by Harima Chemicals, Inc.), a LGA having a package of 10 mm square, an electrode diameter of 0.5 mm, an electrode pitch of 1.0 mm, and a carrier substrate made of alumina was mounted on a 1.6 mm thick glass-reinforced epoxy board having a circuit formed thereon.

Thereafter, the thermosetting resin composition was applied to the periphery of the LGA by means of a dispenser, and then cured by heating in an environment where the temperature was held at about at 150° C. for a period of time of about 60 minutes. The thermosetting resin composition penetrated into the space between the semiconductor device and the circuit board before curing completely.

### Heat Shock Test

The LGA-circuit board assembly prepared as described above was exposed to heat shock testing by exposure to a temperature of about −40° C. for a period of time of about 10 minutes, and thereafter exposure to a temperature to about +125° C. for a period of time of about 10 minutes. After a predetermined number of thermal cycles were reached, the LGA-circuit board assembly was subjected to a continuity test to confirm the electrical connection between the LGA and the circuit board. The assembly was regarded as commercially acceptable when continuity was confirmed to be at least 800 cycles, and unacceptable when continuity was lost due to broken lines before reaching this number of cycles. The compositions passed an acceptable range of thermal cycles.

### Repair

Using a hot air generator, the area around a CSP fixed to the circuit board with the thermosetting resin composition as described above was heated by applying hot air at 250° C. for 1 minute. Then, the CSP could be easily removed by inserting a tool between the CSP and the circuit board, and lifting away the CSP.

While the circuit board was kept at a temperature of about 100° C. by placing it on a hot plate (or by heating it with a far-infrared heater or the like), the resin left on the circuit board was allowed to swell with a solvent such as PS-1 (manufactured by Dai-ichi Kogyo Seiyaku Co., Ltd.) or 7360 (manufactured by Loctite Corporation), and then scraped off with a spatula. The solder left on the circuit board was removed by use of a solder-absorbing braided wire. Residual trace resin remaining on the circuit board was removed with acetone absorbed onto a cloth. The time required for this repairing operation was within about 3 minutes, which was sufficiently short from a practical point of view.

The ease of repair and reworkability of the cured adhesive is expressed below in Table 3 on a relative scale between 1 and 5, with 1 being an unreworkable cured adhesive and therefore incapable of repair and 5 being a reworkable cured adhesive and therefore easily repairable.

TABLE 3

| Sample | Repairability/ |
|---|---|
| No. | Heat |
| 2 | 3.5 |
| 3 | 3 |
| 4 | — |
| 5 | — |
| 6 | 3 |
| 7 | 3.5 |
| 8 | 3.0 |
| 9 | 3.5 |
| 10 | 3.0 |
| 11 | 2 |

The full scope of the invention is measured by the claims.

1. A thermosetting resin composition, reaction products of which are controllably degradable, said composition comprising:
(a) an epoxy resin component;
(b) a curing agent component;
(c) a coreactant, at least a portion of which is represented by the following structure: 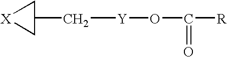
wherein X represents the heteroatoms, oxygen or sulfur; Y may or may not be present, and when present represents alkyl, alkenyl, or aryl; and R represents alkyl, alkenyl, or aryl; and
(d) a stabilizer comprising a cyanate ester.

2. The composition of claim 1, further comprising an inorganic filler component.

3. The composition of claim 1, wherein the coreactant comprises glycidyl neodecanoate.

4. The composition of claim 1, wherein the cyanate ester is selected from the group consisting of 1,3-dicyanatobenzene; 1,4-dicyanatobenzene; 1,3,5-tricyanatobenzene; 1,3-, 1,4-, 1,6-, 1,8-, 2,6- or 2,7-dicyanatonaphthalene; 1,3,6-tricyanatonaphthalene; 4,4′-dicyanato-biphenyl; bis(4-cyanatophenyl)methane; 2,2-bis(3,5 -dichloro-4-cyanatophenyl)propane; 2,2-bis(3,5-dibromo-4-dicyanatophenyl)propane; bis(4-cyanatophenyl)ether; bis(4-cyanatophenyl)sulfide; 2,2-bis (4-cyanatophenyl)propane; tris(4-cyanatophenyl)-phosphite; tris(4-cyanatophenyl)phosphate; bis(3-chloro-4-cyanatophenyl)methane; cyanated novolac; and cyanated bisphenol-terminated polycarbonate or other thermoplastic oligomer.

5. The composition of claim 1, wherein the epoxy resin component includes bisphenol-A-type epoxy resin, bisphenol-F-type epoxy resin, phenol novolac-type epoxy resin, cresol novolac-type epoxy from resin, polyepoxy compounds based on aromatic amines and epichlorohydrin, N-diglycidyl-4-aminophenyl glycidyl ether, N,N,N′,N′-tetraglycidyl-1,3-propylene bis-4-aminobenzoate, polyglycidyl derivatives of phenolic compounds, polyepoxides prepared from polyols, polyglycidyl derivatives of phenol-formaldehyde novolacs, bisphenol-A-type epoxy novolacs, polyglycidyl adducts of amines, polyglycidyl adducts of aminoalcohols, polyglycidyl adducts of polycarboxylic acids, and combinations thereof.

6. The composition of claim 1, wherein the epoxy resin component is present in the composition in an amount within the range of about 20% by weight to about 80% by weight, based on the total weight of the composition.

7. The composition of claim 1, wherein the curing agent component is a member selected from the group consisting of anhydride compounds, aza compounds, amine compounds, amide compounds, imidazole compounds, modified amine compounds, modified imidazole compounds, cationic cure initiators and latent cationic cure initiators.

8. The composition of claim 7, wherein the amine compounds are selected from the group consisting of aliphatic polyamines, aromatic polyamines, alicyclic polyamines and combinations thereof.

9. The composition of claim 7, wherein the amine compounds are selected from the group consisting of diethylenetriamine, triethylenetetramine, diethylaminopropylamine, xylenediamine, diaminodiphenylamine, isophoronediamine, menthenediamine and combinations thereof.

10. The composition of claim 7, wherein derivatives of the amine compounds include epoxy amine additives formed by the addition of an amine compound to an epoxy compound.

11. The composition of claim 7, wherein derivatives of the amine compounds include “ANCAMINE” 2337S.

12. The composition of claim 7, wherein derivatives of the amine compounds have an amine value of 260 (mg KOH/gram) and rapid reactivity above a temperature of 158° F.

13. The composition of claim 7, wherein derivatives of the amine compounds are novolac-type resins modified through reaction with aliphatic amines.

14. The composition of claim 7, wherein derivatives of the amine compounds are substantially insoluble at room temperature in non-basic, organic solvents.

15. A thermosetting resin composition, reaction products of which are controllably degradable, said composition comprising:
(a) an epoxy resin component;
(b) a curing agent component;
(c) a coreactant, at least a portion of which is represented by the following structure: 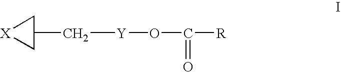
wherein X represents the heteroatoms, oxygen or sulfur; Y may or may not be present, and when present represents alkyl, alkenyl, or aryl; and R represents alkyl, alkenyl, or aryl; and
(d) a stabilizer comprising a cyanate ester, wherein the epoxy resin component is present in an amount in the range of from about 25 to about 75 percent by weight, the curing agent is “ANCAMINE” 2337S and is present in an amount within the range of from about 0.5 to about 5 percent by weight, the coreactant is glycidyl neodecanoate and is present in an amount of about 0.5 to about 5% by weight, and the stabilizer is a cyanate ester and is present in an amount of about 0.5 to about 5% by weight, based on the total composition.

16. The composition of claim 1, which is capable of sealing underfilling between a semiconductor device including a semiconductor chip mounted on a carrier substrate and a circuit board to which said semiconductor device is electrically connected.

17. Reaction products of the compositions in accordance with any one of claims 1-16.
